(19) United States
(12) Patent Application Publication
(10) Pub. No.: US 2022/0282931 A1
(43) Pub. Date: Sep. 8, 2022

(54) HEAT EXCHANGER DEVICE

(71) Applicant: Hamilton Sundstrand Corporation, Charlotte, NC (US)

(72) Inventors: Rafal LEWANDOWSKI, Mrowiny (PL); Berwyn Owain POLLARD, Wolverhampton (GB)

(21) Appl. No.: 17/749,227

(22) Filed: May 20, 2022

Related U.S. Application Data
(62) Division of application No. 16/573,168, filed on Sep. 17, 2019.

(30) Foreign Application Priority Data
Nov. 1, 2018 (EP) 18275168.5

(51) Int. Cl. F28D 9/00; F28F 3/02

(52) U.S. Cl. CPC F28D 9/0062; F28F 3/022; F28F 2255/00

(57) ABSTRACT

A multilayer heat exchanger device comprising: a stack of plates arranged to provide multiple fluid flow paths separated by the plates; wherein at least some of the plates are pin fin plates that each have an array of pins extending outwards from the pin fin plate into the fluid flow paths; and wherein each pin comprises an inner end integrally formed with the pin fin plate, a mid-point along a longitudinal axis of the pin, and an outer end to be bonded to an adjacent plate; wherein the cross sectional area of the pin at the outer end is larger than the cross sectional area at the mid-point.

### CROSS REFERENCE TO RELATED APPLICATIONS

This application is a division of U.S. application Ser. No. 16/573,168 filed Sep. 17, 2019, which claims priority to European Patent Application No. 18275168.5 filed Nov. 1, 2018, the entire contents of which is incorporated herein by reference.

### TECHNICAL FIELD

The invention relates to a heat exchanger device and to a method for manufacturing a heat exchanger device. In an example implementation the heat exchanger device is for aerospace use.

### BACKGROUND

Heat exchangers for transfer of heat between different fluids are very widely used and exist in various forms. Typically heat exchangers are arranged for flow of a primary fluid and a secondary fluid with heat being transferred between the two fluids as they flow through the device. Multi-stream heat exchangers for exchanging heat between more than two fluids also exist in the prior art. Some heat exchangers have a layered structure with a large number of parallel flow paths between plates that separate the flow paths. There may be 50-200 plates, or more, in this type of heat exchanger, typically with alternating hot/cold fluid flow paths either side of each plate. Such heat exchangers can also be referred to as laminate heat exchangers.

The plates generally have features to promote heat transfer and/or turbulent flow of the fluids, such as protrusions extending outward from the body of the plates into the flow of fluid. These features are referred to generally as fins, which includes various geometries of fins forming chambers within the flow passages, such as straight-finned triangular or rectangular arrangements; herringbone, where the fins are placed sideways to provide a zig-zag path; serrated and/or perforated fins, which include cuts and perforations in the fins to augment flow distribution and improve heat transfer; as well as pin fins, where the pin fins comprise an array of pins formed as columnar shapes extending outward from the body of the plates, typically normal to the plane of the plates. These columnar shapes may be referred to individually as pins or pin fins, and heat exchangers using this type of arrangement are generally described as pin fin heat exchangers.

U.S. Pat. No. 8,616,269 discloses an example of a pin fin heat exchanger device with multiple layers. Multiple double sided plates are arranged in a stack with spaces between surfaces of the plates and adjacent plates enclosing fluid flow paths for a first fluid and a second fluid. Pins extend from one or both sides of the plates toward the adjacent plate(s), so that the pins extend into the fluid flow paths. The pins can be formed separately to the plates and mounted to the plates. In particular, the pins are inserted through the plates using through holes. Alternatively the pins can be formed integrally with the plate or plates by chemical etching. The pins can pass through multiple plates. In some cases the pins extending from one plate may have their ends facing the ends of pins extending from the adjacent plate, in which case the heat exchanger device of U.S. Pat. No. 8,616,269 is formed with a gap between the pin ends.

GB 2552956 discloses another example of a pin fin heat exchanger device with multiple layers. The double sided plates are arranged in a stack with the spaces between the surfaces enclosing a fluid flow path. The fluid flow path is formed by a number of pin fins extending between the adjacent surfaces into the fluid flow path and the outer ends off the fins are bonded to the fins of the adjacent plates or between the fins on the adjacent plates. The arrangement of the pin fins allows for a less rigid arrangement of the pin fins within each fluid flow path. The pins of the double sided plate can be aligned together or they can be offset slightly, this provides a means for altering the flow path of the primary and secondary fluid to increase heat transfer.

During the assembly of conventional pin fin heat exchangers made of a plurality of plates, it is typical for the pin fin heads to be joined to the adjacent plate, typically by a braze joint. When under pressures present during operation, this joint may fail if not properly formed. This failure can lead to a chain reaction in the adjacent joints that can result in failure of the unit. In instances where the joint does not fail completely, voids may form. These voids can trap pieces of sediment that may be removed from the heat exchanger surfaces by the fluid. These pieces of sediment disrupt the flow in the fluid flow path and lead to recued thermal efficiency of the heat exchanger. These voids in the braze joints result in reduced active area of the joint and hence reduce the thermal performance of the overall heat exchanger. As a result, conventional heat exchangers are over-engineered, at extra cost, with additional design margins to account for this possible reduced efficiency. There is therefore a need to provide a heat exchanger with an improved braze joint.

### SUMMARY

Viewed from a first aspect, the invention provides a multilayer heat exchanger device comprising a stack of plates arranged to provide multiple fluid flow paths separated by the plates, wherein at least some of the plates are pin fin plates that each have an array of pins extending outwards from at least one side of the pin fin plate into the fluid flow paths; wherein each pin comprises an inner end integrally formed with the pin fin plate, a mid-point along a longitudinal axis of the pin, and an outer end to be bonded to an adjacent plate; and wherein the cross sectional area of the pin at the outer end is larger than the cross-sectional area at the mid-point.

This offers the technical advantage of increasing the surface area of the outer end that is bonded to the adjacent plate, i.e. to a facing surface of the adjacent plate. This may for example be bonding via a brazed joint. As more surface area is present at the outer end then the bond will be stronger and less likely to fail. This advantage allows heat exchangers to be manufactured with a smaller design margin, as the possibility of failure is reduced. This can reduce the cost and complexity of manufacture. This increase in strength, and hence reduced risk of failure, can also mean that less maintenance is required. Reduced maintenance will be advantageous for any application of heat exchanger, and has particular benefits in aerospace applications where maintenance has serious effects on the cost efficiency of an aircraft. An additional advantage may be that due to the greater strength of the bond between the outer end and the adjacent plate (e.g. via the brazing joint), there is a possibility that less bonding material is required (e.g. adhesive, or brazing material); this can further reduce the cost of manufacture and also reduce the weight of the component once assembled. This can be particularly advantageous for aerospace applications, and will also have benefits for other applications of heat exchangers where weight saving is important.

A multilayer heat exchanger device of the type set out in the first aspect has many layers with multiple fluid flow paths each being arranged for heat exchange with adjacent fluid flow paths. The fluid flow paths may all be in parallel planes, and may have parallel flow paths with the same or opposed directions of flow. Thus, the plates may be generally planar in order that adjacent plates enclose a fluid flow path with the principle flow direction being parallel with the planes of the adjacent plates. Alternatively, the plates may have curved shapes with adjacent plates formed as concentric or otherwise complementary curves, with the principle flow direction being along a curved surface of the plates.

A typical heat exchanger device has primary and secondary fluids flowing in adjacent paths in different directions, which maximises the temperature differential between the fluids and thus gives the greatest rate of heat transfer. Such a heat exchanger device is to be differentiated from a heat sink in that heat transfer is promoted via flow of the fluid through the flow paths rather than occurring with passive convection of fluid away from the heat exchange elements as it is heated or cooled. Thus, the heat exchanger may be arranged for forced flow of fluid through the fluid flow paths, for example by being coupled via fluid inlets and outlets to incoming and outgoing fluid passages with a differential pressure. The fluid inlets and outlets may be common to multiple flow paths along multiple sets of plates, for example with a first set of inlets and outlets for a first fluid and a second set of inlets and outlets for a second fluid, the first and second fluids having different temperatures at the respective inlets and heat being transferred between the first and second fluids as they flow through the heat exchanger.

The heat exchanger device may be for use with any required combination of fluids, such as liquid-liquid, liquid-gas or gas-gas heat exchange. The heat exchanger may use air for heating or cooling of another fluid. In some examples the heat exchanger is for aerospace use and the invention thus extends to an aircraft including the heat exchanger device. In context of aerospace use the fluids could include two or more of: atmospheric air, cabin air, engine oil, generator oil, coolant, fuel and so on. Any combination of these fluids can be used within the same heat exchange deice, it is not limited to two types of fluid. The fluid used depends on the requirements of the heat exchanger as different fluid will have different thermal and fluidic properties. Some fluid will move with a lower/higher velocity than others which may be preferable in certain situations to provide the necessary thermal transfer.

Flow paths defined between generally planar plates will be in parallel planes, with heat transfer occurring generally perpendicular to the planes. The heat exchanger device may be arranged with multiple identical flow paths formed by repeating plates. This might be used with alternating fluids in adjacent flow paths, such that a first fluid flows through the first, third and subsequent flow paths, and a second fluid flows through the second, fourth and subsequent flow paths. Alternatively there may be a need for a greater flow cross-section for one fluid, in which case that fluid may be flowed through two adjacent flow paths alternating with one flow path for another fluid, such as by having a first fluid in the first, fourth and seventh flow paths and subsequently in every third flow path and a second fluid in the second and third flow paths, then the fifth and sixth flow paths, and so on.

A further advantageous effect of the increased area of one section of the pins relative to the mid-point is that the area of the flow path between each pin is reduced. This results in an increased flow velocity hence the residency time for a given particle at a location is reduced which increases the thermal transfer performance of the device. Additionally, a smaller are of flow path will increase the Reynolds number of the flow and will tend to more turbulent flow which will further increase the thermal transfer performance of the device.

Multiple pins are distributed across the surface of each of the pin fin plates within the stack of plates. It is preferable that each stack within the stack of plates has a similar distribution to each other. As discussed above, the fluids used will have different thermal and fluidic properties and may therefore require different flow conditions, hence different fin arrangements may be used for different plates within a stack of plates a heat exchanger.

The pin fins of the heat exchange device as described in the first aspect device may be columnar in nature. The pin fins may have cross section that circular. Alternatively, the pin fins may have a cross section that is polygonal such as rectangular. The inner end may have a cross section that is circular and the outer end may have a cross section that is polygonal or vice versa. In examples where the cross section is circular this change in cross sectional may be a gradual, either linear or slightly curved, or it may be over a series of steps.

As described in the first aspect, the area of the outer end is larger than the area at the mid-point of the pin fin, this increase in area from the mid-point may be linear, or it may be stepped. The stepped increase may be in one or more steps. In cases where the cross section increases linearly, the increase may be at an angle between 5 and 10 degrees, optionally between 6.5 and 8.5 degrees.

The increase towards the free surface may increase linearly at an angle between 5 and 10 degrees.

In some examples the smallest cross section may be at the mid-points. Alternatively the smallest cross section will be at a point between the mid-point and the inner end of the pin fin. The cross section of the inner end may be greater than the cross section of the mid-point of the inner fin. Alternatively the cross section of the inner end may be smaller than the mid-point or it may be equal to the mid-point. The cross section of the inner end may be equal to the cross section of the outer end of the pin fin. The middle section of the pin fin may be a constant cross section or the cross section may be increasing or decreasing.

The term mid-point may be defined as a point or a region in a section of the pin that is substantially equidistant from the inner end and the outer end of the pin, along the longitudinal axis. The mid-point region may extend up to 25% the length of the pin in either direction of the point that is equidistant from the inner and outer end of the pin. Optionally the mid-point region may extend up to 10% the length of the pin in either direction of the point that is equidistant from the inner and outer end of the pin.

The increase in cross section of the pin from the smallest to largest may be between 5% and 50%, optionally between 10% to 40%, optionally between 20% and 30%.

In some examples the geometry of each pin fin may be the same across the entire surface of the plate. In other examples, the geometry of the pin fins may vary across the plate. For example, in areas of high stress it may be preferable to have a greater area at the brazed joint, and/or to have a greater area at the integrally formed joint and hence in areas expected to bear higher stresses the pins may have larger cross sectional areas at one or both ends. In addition it may be beneficial to provide a different shape of the outer or inner surface for different pin fins on one plate.

The outer ends of the pins may be shaped in a way that they can be effectively bonded to an adjacent plate. For example they may be flat in order to be bonded with a flat surface or they may be curved in order to bond with a matching curved surface.

The pins may have any suitable size or shape, and the spacing between the pins and/or adjacent plates can be set as required based on the intended use of the heat exchange device. For example the pin may range in width between 0.5 mm to 5 mm, optionally the pin fin width may range between 1 mm and 3 mm. The spacing between the pin fins within a plate may be similar in size as the width of the pin, hence the spacing may be in a range of 0.5 mm to 5 mm, optionally between 1 mm and 3 mm. Alternatively the spacing between the pins may be up to five times the width of the pins, optionally between one or two times the width of the pin, optionally less that the width of the pin. The height of the pins may also vary depending on the volume of fluid passing between the adjacent plates and the required flow path. The height of the pin may be up to five times the minimum width of the pin, optionally one or two times the minimum width of the pins.

It can be advantageous to have the pins relatively close together as this reduces the area of the fluid flow path, hence increasing the fluid velocity. Additionally, increasing the number of pins increases the heat transfer by maximising the ratio of the exposed surface area of the fins to the volume of the fluid in the flow path.

The distribution of pins may be the same for each pin fin plate of the multilayer heat exchanger, alternatively some plates may have more or less spacing between pins. Optionally the pin geometries can vary for each plate depending on the requirement of the heat exchanger or the properties of the fluid used. Differences in pin geometries can be changes in diameter or the variations in cross sectional area along the longitudinal axis as discussed above. The variation in pin geometry and spacing for different plates can be in combination or separately.

The pins may form an array with pins distributed across the body of the plate in a grid pattern, such as a square grid pattern or diamond grid pattern. A diamond grid pattern in this sense has a line between opposite corners of the diamond aligned with the flow direction of the fluid flow path, whereas a square grid pattern has two sides of the square aligned with the flow direction. A diamond grid pattern has adjacent rows of pins that are staggered and this can aid heat transfer. The geometry and size of the pins within the array may differ as discussed above.

The heat exchanger is a multilayer structure with multiple plates, optionally with the plates arranged in a repeating pattern in respect to the flow of fluids. There may for example be at least 40 plates, optionally at least 60 plates and in some cases 100 or more plates. In some cases at least half of the plates are pin fin plates with pins as discussed herein. All of the plates may be pin fin plates. The size and flow capacity of the heat exchanger device increases with the addition of more plates, which adds more flow paths, and thus more plates may be added as required to provide the necessary performance. The heat exchanger device may have a laminate structure, with the multiple plates coupled together by the bonding of the pin ends to adjacent plates and optionally also by a frame or supporting structure that clamps the plates together. The thickness of the heat exchanger device as a whole is set by the total plate thickness, which includes the pin height.

The heat exchanger device may be provided as a part of a larger heat exchanger system, with this larger heat exchanger system comprising fluid inlet and outlet passages as well as optionally other features such as a frame for supporting the plates and manifold structures for distribution of fluid to the flow paths. The heat exchanger device may include end plates of differing form to provide an outside surface of the heat exchanger device having no pins.

The manifolds may include a least a primary fluid inlet manifold, primary fluid outlet manifold, a secondary fluid inlet manifold and a secondary fluid outlet manifold. Thus, the heat exchanger device may be used for heat exchange with at least two fluids. Further manifolds could be added to allow for multistream arrangements with more than two fluids.

Viewed from a second aspect, the invention provides a method for manufacturing a multi-layered heat exchanger device comprising: forming a pin fin plate to be arranged in a stack of plates, each pin fin plate having an array of heat exchanger pins extending outward to an outer end, each pin comprising an inner end integrally formed with the plate and a mid-point between the inner and outer end, wherein the cross sectional area of the pin is greater at the outer end than at the mid-point and wherein an adjacent plate is bonded to the pins at their outer ends.

The method may include providing the heat exchanger device with any of the features discussed above in connection with the first aspect.

The pin may be formed by a process of subtractive manufacturing. Starting from a solid block of material, the pin may be constructed by successively cutting away material until the desired size and shape is formed. This process can be done by typical manufacturing machines such as CNC machines. In some examples the pin fin plates may be machined using a cutting tool with the inverse shape compared to the desired shape of the pins. When forming a complete plate with a plurality of pins for use within a stack of plates, the process would begin with a block the required area of the final plate and the required maximum height of the pins.

An alternative method of manufacture involves additive manufacturing. This may allow for more rapid production of the pin fin heat exchanger plates, especially if complex shapes or irregular geometries are required. In particular, additive manufacturing methods may be advantageous to allow for varying designs for different plates.

The choice of manufacturing process may be determined by the required strength and thermal properties of the pin fin heat exchanger, as each manufacturing method is better suited to certain materials that may have more preferable properties for the requirements.

### BRIEF DESCRIPTION OF THE DRAWINGS

Preferred embodiments of the invention are described below by way of example only and with reference to the accompanying drawings.

FIG. 1 is a cross section view showing a first pin geometry;

FIG. 2 is a cross section view showing another pin geometry;

FIG. 3 is a cross section view showing another pin geometry;

FIG. 4 is a cross section view showing another pin geometry;

FIG. 5 is a cross section view showing another pin geometry;

FIG. 6 is a cross section view showing another pin geometry;

FIG. 7 is a cross section view showing another pin geometry;

FIGS. 8a and 8b show examples of a typical stack of heat exchange plates separated by pin fins, for example using pin fin plates with pins according to any FIGS. 1 to 7; and

FIG. 9 shows a typical pin fin being manufactured using machining techniques.

### DETAILED DESCRIPTION

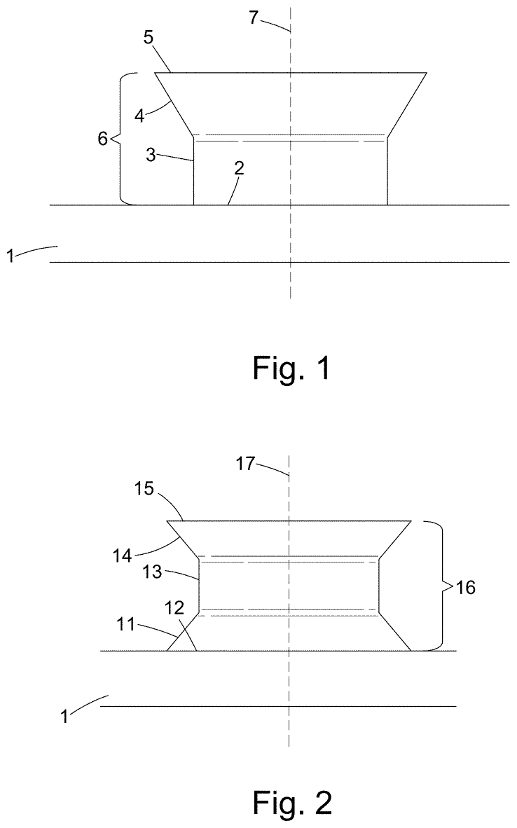

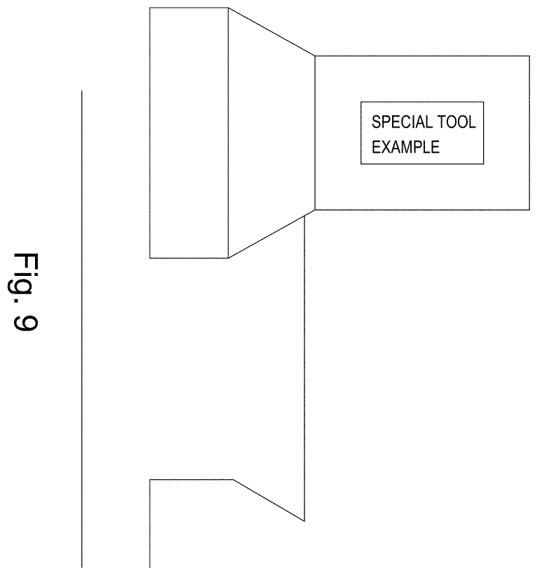

The proposed heat exchanger device can be considered an improvement over known pin fin designed due to the geometry of the pins that are used with pin fin plates. FIG. 1 illustrates one proposed geometry for the pins to be formed integrally with the pin fin plates. These pin fin plates (and likewise pin fin plates with pins as shown in any of FIGS. 2 to 7) could be used in a heat exchanger with a stack of heat exchange plates as described below with reference to FIG. 8. In FIG. 1 the pin fin plate 1 is one of a plurality of plate surfaces within a stack of plates forming the heat exchanger. The pin 6 is integrally mounted to the plate 1 at the inner end of the pin fin. The pin 6 extends from the plate along a longitudinal axis 7. The pin 6 comprises two main sections, a first section 3 extends from the plate with a constant cross section. A second section 4, positioned further from the pin fin plate 1 than the first section 3 along the longitudinal axis 7, extends from the pin fin plate 1 with a linearly increasing cross section, such that the side walls of the pin are diverging, until an outer end 5 is reached, such that the cross section of the outer end 5 is larger than the inner end 2. The cross section of the pin 6 in FIG. 1 is typically circular, therefore the first section 3 is cylindrical and the second section 4 is conical in shape.

The increase in cross section of the pin starts from the mid-point of the pin 6 along the longitudinal axis 7. The skilled person would appreciate that this increase can start from any point along the longitudinal axis.

The cross section of the outer end 5 is between 5% and 50% larger than the cross section of the inner end of the pin 6. The angle of the linear increase from the cylindrical section to the outer surface is between 5° and 45°. This angle depends on the required cross section of the outer end 2 compared to the inner end 5 and the starting point along the longitudinal axis 7 of the linear increase.

FIG. 1 shows one of the possible pin geometries. Different pin geometries can be used for other plates or for different parts of the same plate. FIG. 2 shows another possible pin geometry that can be used within the heat exchange device. As with the pin 6 of FIG. 2, the inner end 12 of pin 16, shown by FIG. 2, is integrally formed with the plate 1. In the pin of FIG. 2, the cross sectional area of the inner 12 and outer end 15 are equal. The pin comprises three distinct sections, as opposed to the two in FIG. 1. A first section 11 extends away from the plate 1, along the longitudinal axis 17, with a linearly decreasing cross section, such that the side walls are converging. A second section 13 is positioned further from the plate 1 along the longitudinal axis 17, and extends from the end of the first section 11. Second section 13 extends from the end of first section 11 with a constant cross sectional area. A third section 14 extends away from the plate 1 from the end of the second section 13. The cross sectional area of the third section is linearly increasing along the longitudinal axis, such that the side walls are diverging, so that the outer end 15 of the third section 14 has the same cross sectional area of the inner end 12 of the first section 11.

The cross section of the pin 16 is circular, therefore the first and third sections are conical, and the middle, second, section is cylindrical.

As with the pin 6 shown in FIG. 1, the maximum cross sectional area of the pin 16 may be between 5% and 50% larger than the minimum cross sectional area. The angle of converging/diverging of the outer/inner ends can be between 5° and 45°, depending on the minimum and maximum cross sectional areas required. Typically the angles of convergence and divergence off the first and third sections are equal, however, depending on the geometry required these angles can be different. Similar ranges of dimensions as the pin of FIG. 1 are applicable.

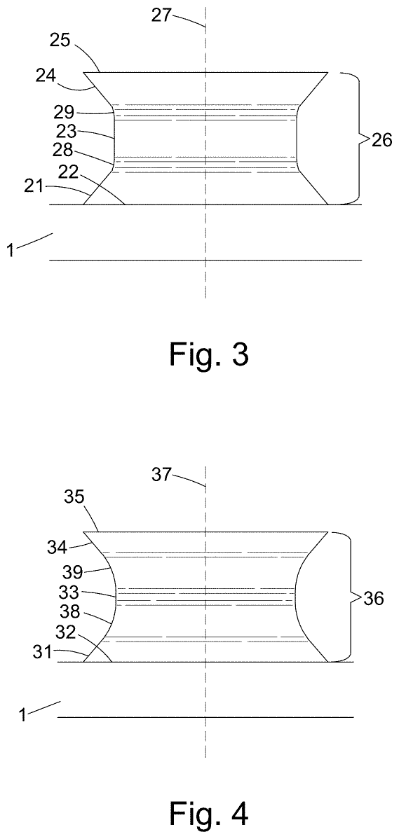

FIGS. 3 and 4 show other possible pin geometries 26, 36. As with the pin geometry of FIG. 2, the inner end 22, 32 and outer end 25, 35 have equal cross sectional areas. The pins 26, 36 comprise four distinct sections. A first section 21, 31, extends from the plate 1 along the longitudinal axis 27, 37, with a linearly decreasing cross sectional area, such that the side walls of the first section 21 are converging. The second section 28, 38 extends from the end of the first section 21, 31, away from the plate 1. The cross sectional area of the second section 28, 38 is exponentially decreasing along the longitudinal axis 27, 37 in a direction away from the plate 1. The angle of the side walls of section 28, 38 to the longitudinal axis is decreasing such that the angle gradually changes from the angle of the linear decrease of the first section 21, 31, until the side wall 28, 38 is almost parallel to the longitudinal axis 27, 37. The third section 23, 33 extends from the end of the second section 28, 38, with a constant cross sectional area, such as the side walls of the third section 23 are parallel to the longitudinal axis 27, 37. The fourth section 29, 39 extends from the end of the third section 23, 33, away from the plate 1. The cross sectional area of the fourth section 29, 39 is exponentially increasing along the longitudinal axis in a direction away from the plate 1. A fifth section 24, 34, extends from the end of the fourth section 29, 39 in a direction away from the plate 1. The cross sectional area of the fifth section is linearly increasing along the longitudinal axis in a direction away from the plate 1, such that the fifth section 24, 34 is diverging. The divergence continues to the outer end 25, 35 of the pin 26, 36, such that the cross sectional area of the outer end 25, 35 is approximately equal to the cross sectional area of the inner end 22, 32. The angle of the side walls of section 29, 39 to the longitudinal axis changes from approximately parallel to the longitudinal axis to the angle of the divergence of the fifth section 24, 34.

The relative proportions of the first to fifth sections for the pins shown in FIGS. 3 and 4 can vary. For example in FIG. 3, the length of first and fifth sections along the longitudinal axis 27, 37 are each approximately 30% of the distance between the inner and outer end, while in FIG. 4 they are each approximately 15% of the distance between the inner and outer end. The second and fourth sections in FIG. 3 are each approximately 10% of the distance between the inner and outer ends. In FIG. 4, the second and fourth sections are each approximately 30% of the distance between the inner and outer ends. The third section in the pin geometry 26 shown in FIG. 3 is 30% of the distance between the inner and outer end of the pin, whereas in FIG. 4 the third section is 10% of the distance between the inner and outer end. It will appreciate that the proportions of each of the five sections can vary, as demonstrated by the pins shown in FIGS. 3 and 4. Typically the proportions of the first and fifth sections will be equal, and so will the proportions of the second and third sections. However, depending on the structural or flow requirements they can differ. In some cases the proportion of the third section can be zero, so that the side wall of the pin forms complete parabolic curve between the inner and outer end of the pins with no distinct section where the side wall is parallel to the longitudinal axis.

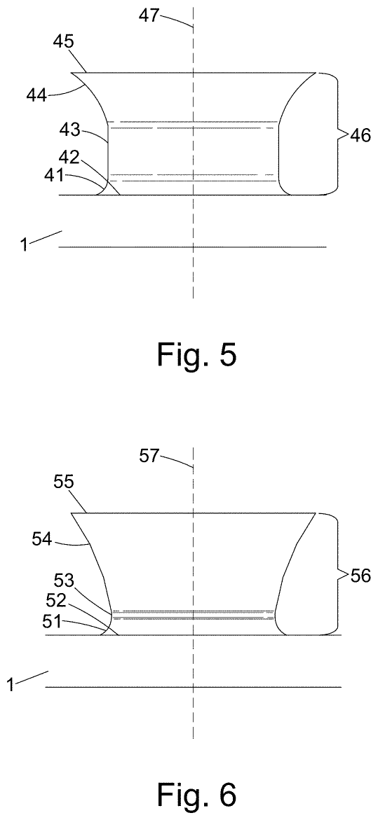

FIGS. 5 and 6 show other alternative pin geometries. In the figures the inner end 42, 52 has a smaller cross sectional area than the outer end 45, 55 and the pins are made of three distinct sections. A first section 41, 51 extends from the inner end 42, 52 of the pin 46, 56 along the longitudinal axis 47, 57 in a direction away from plate 1. The cross sectional area of the first section 41, 51 decreases exponentially, such that the side wall of the first section is converging. A second section 53, 43 extends from the end of the first section 42, 52 along the longitudinal axis 47, 57 in the direction away from the plate 1. The second section 43, 53 extends in the direction of the longitudinal axis with a constant cross sectional area. A third section 44, 54 extends from the end of the second section along the longitudinal axis 47, 57 in a direction away from the plate 1. The third section 44, 54 extends from the end of the second section to outer end 45, 55 of the pin 46, 56. The cross sectional area of the third section 44, 54 increases exponentially, such that the side wall of the third section 44, 54 is diverging. The divergence of the third section 44, 54 is greater in magnitude than the convergence of the first section 41, 51 such that the cross sectional area of the outer end 45, 55 is larger than the inner end 42, 52.

As with the pins shown in FIGS. 3 and 4, the size of the three sections as a proportion of the total height of the pin can vary. As an example the first section in FIGS. 5 and 6 are approximately 15% of the distance between the inner and outer end of the pin. In FIG. 5, the second section is approximately 45% of the total distance between the inner and outer end of the pin, while in FIG. 6, the second section is approximately 5% of the total distance between the inner and outer end of the pin. In FIG. 5, the third section is approximately 40% of the total distance between the inner and outer end of the pin, while in FIG. 6, the third section is approximately 80% of the total distance between the inner and outer end of the pin. In some cases the proportion of the third section can be zero, so that the side wall of the pin forms complete parabolic curve between the inner and outer end of the pins with no distinct section where the side wall is parallel to the longitudinal axis.

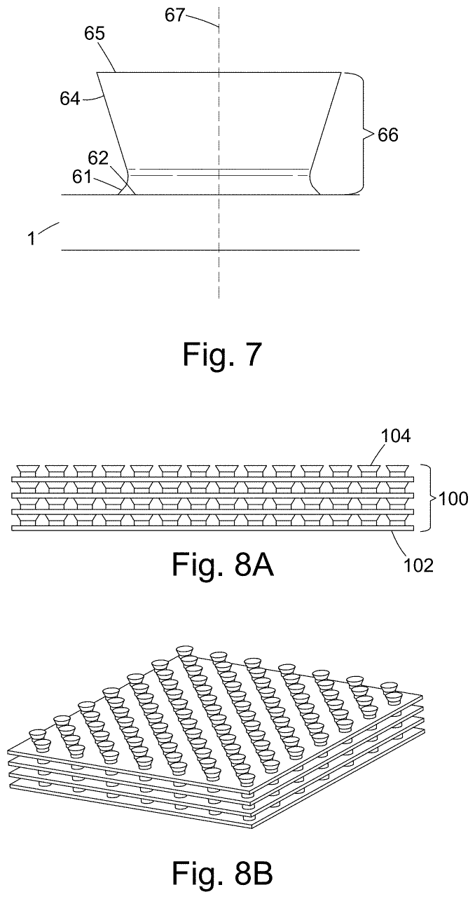

Another possible geometry is shown in FIG. 7. The pin 66 comprises two distinct sections. As in the pins shown by FIGS. 5 and 6, the first section extends from the inner end 62 of the pin along the longitudinal axis 67, in the direction away from the plate 1. The cross sectional area of the first section is exponentially decreasing similar to the first section of the pins shown in FIGS. 5 and 6. The side wall of the first section 61 converges until it is approximately parallel to the longitudinal axis 67. The second section 64 extends from the end of the first section 61 to out end 65 of the pin. The cross sectional area of the second section 64 linearly increases, such that the side walls are diverging and such that the cross sectional area of the outer end 65 is greater than the inner end 62. As is the case with the other possible pin geometries the relative proportions of each section may differ. As an example, in FIG. 7, the first section is 20% the total distance between the inner and outer end, and the second section is approximately 80% of the total distance between the inner and outer ends of the pin 66. The area of the outer end may be between 5% and 50% larger than the minimum cross sectional area of the pin 66. The angle of the linear increase of the cross sectional area of the second section 64 may be between 5° and 45° depending on the required area of the outer end 65 and the minimum cross sectional area of the pin 66.

FIGS. 8A and 8B show a stack of heat exchange plates 100. Each plate 102 is separated by an array of pins 104. The geometry of the pin can be according to any of the possibilities shown in FIGS. 2 to 7, or variations thereof depending on the requirement of the fluid used in each flow paths, or the structural requirements. As will be appreciated from FIG. 8A, the spacing between each plate is determined by the height of the pins. In most cases the each pin attached to one plate will have same plate, however to accommodate for the possibility of curved plates the pins within a certain plate may differ in height.

FIGS. 8A and 8B also show an even spacing of pins throughout the heat exchange device. It is possible to use different types of fluid in each layer of the heat exchanger, which may have different fluid characteristics and will therefore require different flow paths. Therefore, it may be necessary for the spacing between pins to be different for each plate depending on the fluid used.

FIG. 8B shows the pins arranged in a diamond pattern, however they can also be arranged in a square pattern or alternatively the pins can be arranged in an irregular pattern. It is also possible for the pin on each plate within a stack of plates to be arranged with a different pattern as each fluid type will be better suited to a particular arrangement of pins.

In the stack of plates the inner end of each pin 104 is integrally formed as part of the plate and the outer end of each pin is free. When assembled as a stack the outer end is joined to the bottom surface of the adjacent plate by brazing. The larger area of the free end provides a stronger braze joint.

FIG. 9 shows a typical tool used for manufacturing the pin fin plate for use in a heat exchanger by subtractive manufacturing. The tool is required to match with the outer surface of the pin, and therefore to manufacture the different pin geometries shown in FIGS. 1 to 7, then a different tool is required in each case.

As an alternative the pin fin plate can be produced using additive manufacturing. This method allows for different pin geometries to be manufactured without the need for redesigning the tools. In additional additive manufacturing may be capable more rapidly producing the pin fin plates, especially where there are complex geometries or if there is a requirement for varying geometry, size or spacing for different plates.

1. A multilayer heat exchanger device comprising:
a stack of plates arranged to provide multiple fluid flow paths separated by the plates;
wherein at least some of the plates are pin fin plates that each have an array of pins extending outwards from the pin fin plate into the fluid flow paths; and
wherein each pin comprises an inner end integrally formed with the pin fin plate, a mid-point along a longitudinal axis of the pin, an outer end to be bonded to an adjacent plate;
wherein the cross sectional area of the pin at the outer end is larger than the cross sectional area at the mid-point; and
wherein the cross sectional area of the outer end is equal to the cross sectional area of the inner end.

2. The multilayer heat exchanger device as claimed in claim 1, wherein the array of pins is distributed across the body of the plate in a grid pattern.

3. The multilayer heat exchanger device as claimed in claim 2, wherein the array of pins have the same distribution across the body of each plate within the stack of plates.

4. The multilayer heat exchanger device as claimed in claim 1, wherein the pins have a circular cross section.

5. The multilayer heat exchanger device as claimed in claim 1, wherein the cross sectional area of the outer end is larger than the cross sectional area of the inner end.

6. The multilayer heat exchanger device as claimed in claim 1, wherein any change in cross sectional area is linear along the longitudinal axis of the pin.

7. The multilayer heat exchanger device as claimed in claim 1, wherein any change in cross sectional area is exponential along the longitudinal axis of the pin.

8. The multilayer heat exchanger device as claimed in claim 1, wherein the outer ends of the pins are bonded to the adjacent plate by brazing.

9. The multilayer heat exchanger device as claimed in claim 1, wherein the pins have a width in the range 0.5 to 5 mm.

10. The multilayer heat exchanger device as claimed in claim 1, wherein a spacing between the pins is similar to the width of the pins.

11. The multilayer heat exchanger device as claimed in claim 1, wherein a spacing between the pins is between 1 and 2 times a width of the pins.

12. The multilayer heat exchanger device as claimed in claim 1, wherein a spacing between the pins is up to 5 times a width of the pins.

13. The multilayer heat exchanger device as claimed in claim 1, wherein the increase in cross sectional area from the minimum point to the outer end is between 5% and 50%.

14. The multilayer heat exchanger device as claimed in claim 13, wherein the increase in cross sectional area from the minimum point to the outer end is between 20% and 30%.

15. The multilayer heat exchanger device as claimed in claim 1, wherein the pin geometry varies across each plate within the stack of plates.

16. The multilayer heat exchanger device as claimed in claim 1, wherein the pin geometry is the same across each plate within the stack of plates.

17. The multilayer heat exchanger as claimed in claim 16, wherein the pin geometry varies between each plate within the stack of plates.
